(19) United States
(12) Patent Application Publication
(10) Pub. No.: US 2010/0117468 A1
(43) Pub. Date: May 13, 2010

(54) FAN MOTOR

(75) Inventor: Yukinobu Kurita, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/443,560

(22) PCT Filed: Sep. 26, 2007
(86) PCT No.: PCT/JP2007/001040

§ 371 Date: Dec. 30, 2009

(30) Foreign Application Priority Data
Sep. 29, 2006 (JP) 2006-270024

(51) Int. Cl. H02K 11/00

(52) U.S. Cl. 310/71; 310/68 D; 310/68 B

(57) ABSTRACT

A fan motor may include a stator supporting portion for supporting a stator with a drive coil, a rotor rotatably supported by a rotating center shaft (rotating shaft) provided at the stator supporting portion, a magnet placed on the inner peripheral side of the rotor so as to face the drive coil, a fan (impeller portion) provided on the outer peripheral side of the rotor, a control board having a drive control IC performing polarity switching control of the drive coil, a hollow tubular frame having a suction opening and a discharge opening, and an installation member (guide blade) for installing the stator supporting portion into the hollow portion of the frame. The control board is placed in the frame so as to be substantially in parallel with the rotating center shaft.

### FIELD OF THE INVENTION

The present invention relates to a fan motor which is used as an air cooling device in an information apparatus such as a personal computer and specifically relates to a fan motor which is capable of improving heat radiation characteristics.

### BACKGROUND ART

Recently, with a tendency of advanced performance and function of an information apparatus, heat generation of electronic components (for example, CPU and the like) provided in the inside of the information apparatus has increased and thus importance of an efficient air-cooling has been increasing. For example, in a server as a host computer, a plurality of CPUs and memories are disposed for attaining a high density mounting and a high speed operation and thus a plurality of fan motors are disposed to enhance an air-cooling efficiency.

For example, in an axial fan motor disclosed in Patent Reference 1, drive circuit components such as power transistors are disposed within a case which is protruded from a housing. An opening is formed in the case and a part of air which is generated by rotor blades and flown from the inside of the apparatus toward the outside is flown into through the opening. In this manner, when the rotor blades are rotated, the drive circuit components are self-cooled i.e., forcibly cooled by the air having flown into the case and, as a result, a heat generating source such as a power transistor which is disposed in the drive circuit is cooled.
[Patent Reference 1] Japanese Patent Laid-Open No. 2002-112499 (paragraph [0018], FIG. 1)

### DISCLOSURE OF THE INVENTION

### Problems to be Solved by the Invention

However, as described above, with a recent advanced performance and function of an information apparatus, a further improvement for heat radiation characteristic is required. For example, in the axial fan motor which is described in Patent Reference 1, self-cooling is performed by utilizing air entering from the opening as described above but an inflow amount of air entering from the opening has a limit and thus an effect of air-cooling is limited. Further, there is a requirement to reduce the number of fan motors as much as possible, for example, which are used in a server. However, when the number of the fan motors is really reduced, the rotation number of the fan motor is required to increase and, when the rotation number is increased, heat generated from the fan motor can not be radiated sufficiently.

In view of the problems described above, the present invention may provide a fan motor which is capable of providing a higher heat radiation characteristic.

### Means to Solve the Problems

In order to solve the problems described above, at least an embodiment of the present invention provides as follows.

According to an embodiment of the present invention, there may be provided a fan motor including a frame provided with an inlet port and an outlet port and formed in a hollow tubular shape, a stator provided with a drive coil, a stator support part which supports the stator, a rotor which is rotatably supported by the stator support part, a magnet which is disposed on the rotor so as to face to the drive coil, a fan which is provided on an outer peripheral side of the rotor for generating airflow from the inlet port to the outlet port, a control circuit board having a drive control IC for controlling switching of polarity of the drive coil, and a mounting member which mounts the stator support part within the hollow tubular shape of the frame. The control circuit board is disposed in a substantially parallel to a rotation center axis of the rotor within the frame.

According to this embodiment, in the fan motor including a rotor which is rotatably supported by (rotation center shaft which is provided in) a stator support part, a fan, a control circuit board having a drive control IC, and a mounting member for mounting the stator support part, the control circuit board is disposed in the frame so as to be substantially parallel to the rotation center shaft of the rotor and thus a high degree of heat radiation characteristic is obtained.

In other words, in the axial fan motor which is disclosed in the conventional Patent Reference 1, the case which accommodates a drive circuit component (drive circuit board) on which power transistors and the like are mounted is disposed to be perpendicular to the rotation center shaft and is cooled by utilizing air which is flown into from an opening arranged in the case. Therefore, the drive circuit component cannot be directly cooled by the air. (Accordingly, an opening is formed in the case in Patent Reference 1). However, according to this embodiment, since the control circuit board is disposed to be substantially parallel to the rotation center shaft, the control circuit board is disposed within airflow by the rotor blade from the inlet port to the outlet port of the frame and thus airflow is directly passed through the entire or a part of the control circuit board. Therefore, a high degree of heat radiation characteristic is obtained. In accordance with an embodiment, the control circuit board may be covered by a certain member and, in this case, an opening may be formed in the certain member.

In accordance with an embodiment of the present invention, a sensor circuit board is provided which includes a magnetic pole detection sensor for detecting a magnetic pole of the magnet to generate a magnetic pole detection signal, and the sensor circuit board is disposed so that the magnetic pole detection sensor is located in a vicinity of the magnet, and the sensor circuit board is provided separately from the control circuit board.

According to this embodiment, the sensor circuit board having the magnetic pole detection sensor is disposed so that the magnetic pole detection sensor is located in a vicinity of the magnet and the sensor circuit board is provided separately from the control circuit board and thus degree of freedom for arranging the control circuit board and the sensor circuit board is improved. Therefore, the control circuit board and the sensor circuit board can be accommodated within a limited space of the frame without largely disturbing airflow, for example, without stagnating airflow from the inlet port to the outlet port of the frame which is generated by the rotor blades. Further, distances of components such as the drive IC on the control circuit board, the sensor on the sensor circuit board and the like can be widened.

In accordance with an embodiment of the present invention, an electric current supply means is provided for supplying an electric current to the drive coil on the basis of a control signal from the drive control IC, and at least a part of the electric current supply means is disposed on an extending part of the control circuit board which is extended toward an inner wall of the frame.

According to this embodiment, an electric current supply means for supplying an electric current to the drive coil on the basis of a control signal from the drive control IC is provided in the fan motor, and at least a part of the electric current supply means is disposed on an extending part of the control circuit board which is extended toward an inner wall of the frame. Therefore, the electric current supply means (for example, FET, power transistor or the like) which commonly generates large amount of heat can be disposed within airflow from the inlet port to the outlet port of the frame that is generated by the rotor blades. As a result, the electric current supply means is effectively air-cooled and thus heat radiation characteristic of the entire fan motor can be improved.

In accordance with an embodiment of the present invention, a connecting part for power supply or for a control line is provided on the extending part near the inner wall of the frame.

According to this embodiment, a connecting part for power supply or for a control line is provided on the extending part near the inner wall of the frame. Therefore, in order that electric power or a control signal is supplied to the fan motor from the outside, electrical connection may be simply arranged without being largely incurred by an effect due to airflow from the inlet port to the outlet port of the frame which is generated by the rotor blades.

In accordance with an embodiment of the present invention, a cover member is provided which is fixed to the stator support part for covering the sensor circuit board, and the cover member is formed with a slot which is cut in a direction parallel to the control circuit board.

According to this embodiment, the cover member which is fixed to the stator support part for covering the sensor circuit board is provided and the cover member is formed with a slot which is cut in a direction parallel to the control circuit board. Therefore, the control circuit board is firmly fixed to the fan motor by means of that the control circuit board is pinched by utilizing (inserted or fitted to) the slot. Further, wobbling of the control circuit board is prevented by being fixed to the slot.

In accordance with an embodiment of the present invention, the cover member is formed with a circuit board support part which is extended toward an inner wall of the frame from an end part of the slot in a direction perpendicular to the rotation center axis for supporting the control circuit board.

According to this embodiment, the cover member is formed with a circuit board support part which is extended toward an inner wall of the frame from an end part of the slot in a direction perpendicular to the rotation center axis for supporting the control circuit board. Therefore, the control circuit board which is disposed to be parallel to the rotation center shaft is securely fixed and wobbling of the control circuit board can be prevented securely.

In accordance with an embodiment of the present invention, the circuit board support part is formed with a groove part for supporting the extending part of the control circuit board.

According to this embodiment, the circuit board support part is formed with a groove part for supporting the extending part of the control circuit board. Therefore, the control circuit board is firmly fixed by means of that a part of the control circuit board is fitted into the groove part.

In accordance with an embodiment of the present invention, a face of the circuit board support part which is opposite to a face formed with the groove part is formed in a stream-line shape whose thickness becomes thinner toward windward of the airflow.

According to this embodiment, a face of the circuit board support part which is opposite to a face formed with the groove part is formed in a stream-line shape whose thickness becomes thinner toward windward of the airflow. Therefore, a wind pressure resistance is reduced and thus air amount supplied by the fan motor can be increased. In this embodiment, the “stream-line shape” is a shape whose tip end may be a sharp shape such as a so-called triangular shape or an arrowhead shape, or may be formed in any shape where a wind pressure resistance can be reduced.

### Effects of the Invention

As described above, in the fan motor in accordance with at least an embodiment of the present invention, the control circuit board having a drive control IC is disposed in the frame so as to be substantially parallel to the rotation center shaft of the rotor. Therefore, airflow generated by the rotor blades is directly passed through the entire or a part of the control circuit board and thus a high degree of heat radiation characteristic can be obtained.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a) and 1(b) are views showing a mechanical structure of a fan motor in accordance with an embodiment of the present invention.

FIGS. 2(a) and 2(b) are enlarged views showing a control circuit board.

FIG. 3 is a circuit diagram showing an electrical structure of a fan motor in accordance with an embodiment of the present invention.

FIGS. 4(a) and 4(b) are enlarged views showing a control circuit board which is mounted on a fan motor in accordance with another embodiment of the present invention.

FIG. 5 is a sectional view showing a fan motor in accordance with another embodiment of the present invention.

### EXPLANATION OF REFERENCE NUMERALS

1 fan motor
11 blade part (fan)
12 magnet
13 yoke
14 rotation shaft
15 hub
16 ball bearing
17 laminated core
18 core support member
19 guide blade
20 spring
21 drive coil
22 sensor circuit board
23 control circuit board
24 connecting part (connecting plate, connector)
25 cover part
26 stator support part
27 magnetic pole detection sensor
28 support part
30 fan case
100 rotor
200 stator

An embodiment of the present invention will be described below with reference to the accompanying drawings.

### [Mechanical Structure]

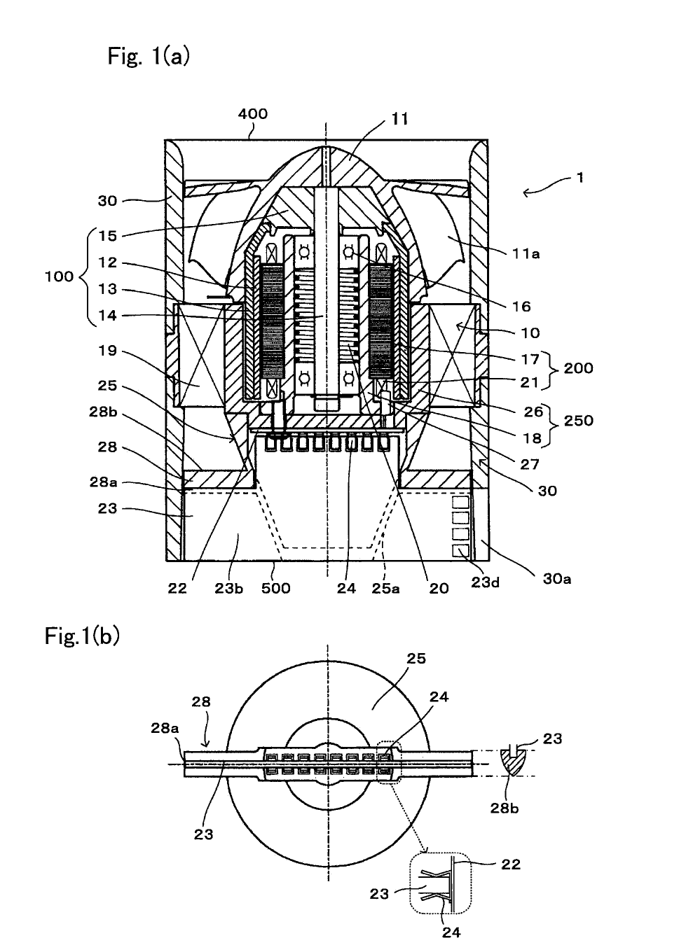

FIGS. 1(a) and 1(b) are views showing a mechanical structure of a fan motor 1 in accordance with an embodiment of the present invention. Specifically, FIG. 1(a) is a longitudinal sectional view showing the fan motor 1 and FIG. 1(b) is a view showing the fan motor 1 shown in FIG. 1(a) which is viewed from an under side in the drawing (frame is omitted).

The fan motor 1 shown in FIG. 1(a) includes a fan case 30 as a hollow pipe-shaped frame which is provided with an inlet port 400 and an outlet port 500, a stator 200 provided with a drive coil 21, a stator support part 26 which supports the stator 200, a rotor 100 which is rotatably supported by the stator support part 26, a magnet 12 which is disposed on the rotor 100 so as to face the drive coil 21, a blade part (fan) 11 which is provided on an outer peripheral side of the rotor 100 for generating airflow from the inlet port 400 to the outlet port 500, a control circuit board 23 having a drive control IC 23a for controlling switching of the polarity of the drive coil 21, and guide blades 19 as a mounting member for mounting the stator support part 26 within a hollow portion of the fan case 30. The control circuit board 23 is disposed within the fan case 30 in a substantially parallel manner with respect to a rotation center axis of the rotor 100. In this embodiment, a three-phase brushless motor is used as a motor 10. However, the present invention is not limited to this embodiment. For example, a motor in a single-phase full-wave drive system or a motor in a two-phase drive system may be used.

As shown in FIG. 1(a), the motor 10 of the fan motor 1 includes the rotor 100, the stator 200, ball bearings 16 as a bearing, a circuit board assembly comprising the control circuit board 23, a sensor circuit board 22 and a connecting part (connecting plate) 24. The rotor 100 includes the magnet 12, a yoke 13, a rotation shaft 14 and a hub 15, and the stator 200 includes a laminated core 17, a core support member 18, the drive coil 21 and the stator support part 26.

The blade part 11 is provided with a plurality of blades 11a and the blades 11a are formed in a shape so that wind is sent from the inlet port 400 to the outlet port 500 (from the upper to the lower in FIG. 1(a)) by rotation of the blade part (fan) 11. The blade part 11 is mounted on the rotation shaft 14 through the hub 15 and is rotated together with the rotation shaft 14.

The hub 15 is mounted with the magnet 12 through the yoke 13. The magnet 12 is formed in a cylindrical shape and is alternately magnetized with an “N”-pole and an “S”-pole in a circumferential direction. In addition, an inner peripheral face of the magnet 12 is disposed so as to face an outer peripheral face of the laminated core 17. The rotation shaft 14 and the blade part 11 are rotated through the yoke 13 and the hub 15 by an electromagnetic force based on a magnetic field generated in the vicinity of the laminated core 17. In this embodiment, the rotation shaft 14 is supported by the core support part 18 through the ball bearings 16. Further, a lateral pressure is applied to the ball bearing 16 in a rotation shaft direction by the spring 20 to stabilize rotation of the rotation shaft 14 and the blade part (fan) 11.

The laminated core 17 is fixed to the core support member 18 and the drive coil 21 is wound around the laminated core 17 (see FIG. 1(a)). When a switching-controlled electric current is supplied to the drive coil 21 from the control circuit board 23, a drive magnetic field is generated in the vicinity of the laminated core 17. As described above, the magnet 12 structuring the rotor 100 is rotated by the electromagnetic force of the drive magnetic field.

The core support member 18 is fixed to the stator support part 26 to structure a part of the stator support part 26. The guide blade 19 is provided on an outer side in a radial direction of the stator support part 26 for guiding air which is sent by the blade part 11. The guide blade 19 is a mounting member for mounting the stator support part 26 on the fan case 30 (frame) and is provided with a function for converting turbulent flow, which is generated by rotation of the blade part 11, into a direct flow. In this embodiment, one end of the guide blade 19 is mounted on the stator support part 26 and the other end is mounted on the inner side of the fan case 30, and a plurality of the guide blade 19 is formed radially from the outer peripheral face of the stator support part 26. The wind converted into the direct flow blows on the control circuit board 23 more efficiently. In this manner, the control circuit board 23 (especially, a drive control IC 23a and FET units 23e described below) is cooled down effectively. In this embodiment, the fan case 30 as a frame in a hollow tubular shape is formed in a rectangular tube whose cross section is quadrangular.

In the present invention, an axial center of the rotation shaft 14 is a rotation center axis of the rotor 100. The stator 200 includes the coil (drive coil) 21 and the laminated core 17, and the stator support member 250 includes the core support member 18 and the stator support part 26. Further, the rotation shaft 14, the magnet 12, the yoke 13 and the hub 15 structures the rotor 100. Further, the stator support part 26 is integrally molded with the guide blade 19 as a mounting member and the core support member 18 is fixed to a bottom part on an inner peripheral side of the cup-shaped stator support part 26 with a screw or the like. In addition, a sensor circuit board 22 is mounted on an opposite side of the stator support part 26 with respect to the core support member 18.

As described above, the stator support part 26 supports the stator 200 and the rotor 100 is rotatably supported through the rotation shaft 14 which is provided in the hub 15. Further, the magnet 12 is disposed on the inner peripheral face of the rotor 100 so as to face the drive coil 21 and the blade part 11 as a fan is provided on the outer peripheral side of the rotor 100. The rotor 100 and the stator 200 are disposed within the fan case 30 (frame in a hollow tubular shape). In addition, the stator support part 26 is mounted within the fan case 30 by the guide blade 19.

On the other hand, in FIG. 1(a), a circuit board assembly comprised of the sensor circuit board 22, the control circuit board 23 and the connecting part 24 is provided on the outlet port 500 side of airflow in the inside of the fan case 30 of the fan motor 1.

The sensor circuit board 22 is formed in a disk-like shape having a size substantially the same as the inner peripheral bottom part of the stator support part 26. The sensor circuit board 22 is provided with a magnetic pole detection sensor 27 for detecting magnetic poles of the magnet 12 to generate a magnetic pole detection signal. In other words, when the magnet 12 is rotated together with the blade part 11, the magnetic field in the vicinity of the magnetic pole detection sensor 27 such as a Hall IC is varied. When the magnetic pole detection sensor 27 detects variation of the magnetic field, it is transmitted to the control circuit board 23 as a magnetic pole detection signal. In this embodiment, the magnetic pole sensors 27 on the sensor circuit board 22 are disposed in the vicinity of the magnet 12 at positions facing the inner peripheral face of the magnet 12 with an equal interval in the circumferential direction. In addition, as shown in FIGS. 1(a) and 1(b), the sensor circuit board 22 is formed with the connecting part 24 for holding the control circuit board 23. The connecting part 24 is formed with a plurality of metallic pins and is electrically connected to the sensor circuit board 22 through the metallic pins. Further, the sensor circuit board 22 and the control circuit board 23 are separately structured.

The control circuit board 23 is fixed to the sensor circuit board 22 through the connecting part 24 and is electrically connected to the sensor circuit board 22 by using a plurality of the metallic pins formed in the connecting part 24. In accordance with an embodiment of the present invention, any connecting technique of the sensor circuit board 22 with the control circuit board 23 may be utilized. For example, a slot may be formed for connection or a socket may be used for connection.

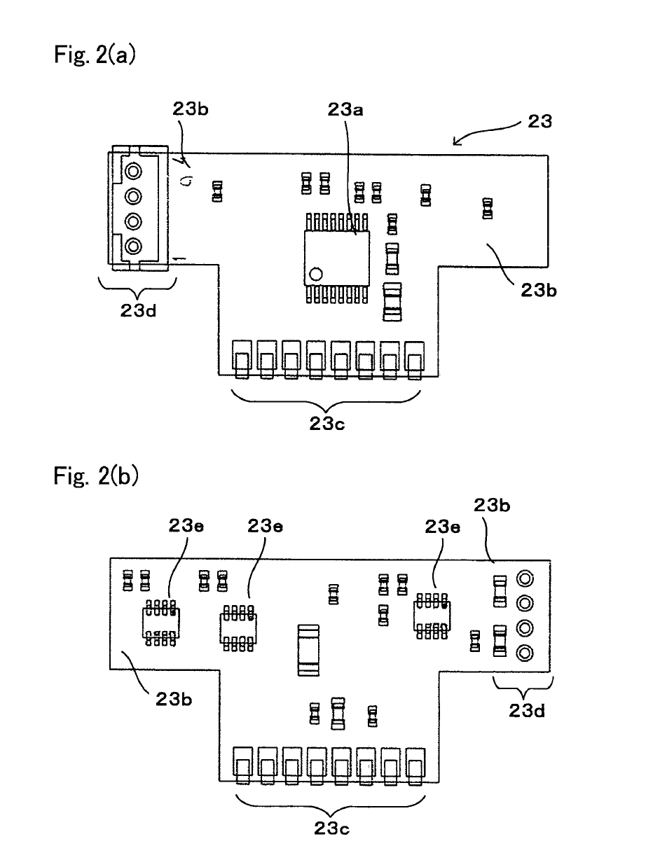

As shown in FIGS. 2(a) and 2(b) described below, the control circuit board 23 is provided with the drive control IC 23a where switching of a magnetism of the drive coil 21 is controlled. Further, as shown in FIG. 1(a), the control circuit board 23 is formed in a “T”-shape and is provided with extending parts 23b extending toward an inner wall of the frame.

The cover member 25 is formed in a truncated-cone shape and is fixed to the stator support part 26 with a screw to cover the sensor circuit board 22. Further, the cover member 25 is formed with a slot 25a so as to be parallel to the control circuit board 23 and the circuit board support part 28 is formed from an end part of the slot 25a to the fan case 30 in a direction perpendicular to the rotation shaft 14.

The circuit board support part 28 is fixed to the stator support part 26. Further, the circuit board support part 28 is formed with a groove part 28a which supports the extending part 23b of the control circuit board 23 so as to be roughly perpendicular to the slot 25a. Further, an opposite face (convex face 28b) of the circuit board support part 28 to a face formed with the groove part 28a is formed in a stream-line shape whose thickness becomes thinner toward the windward of airflow (see FIG. 1(b)). In the embodiment described above, the connecting part 24 is a connector and, as shown by the dotted line frame in FIG. 1(b), the connecting part 24 is fixed to the sensor circuit board 22 and inserting connection part 23c of control circuit board 23 is inserted into metal pins formed in the connector to electrically connect (fix) the sensor circuit board 22 with the control circuit board 23.

FIGS. 2(a) and 2(b) are enlarged views showing the control circuit board 23. Specifically, FIG. 2(a) shows a front face of the control circuit board 23 and FIG. 2(b) shows a rear face of the control circuit board 23.

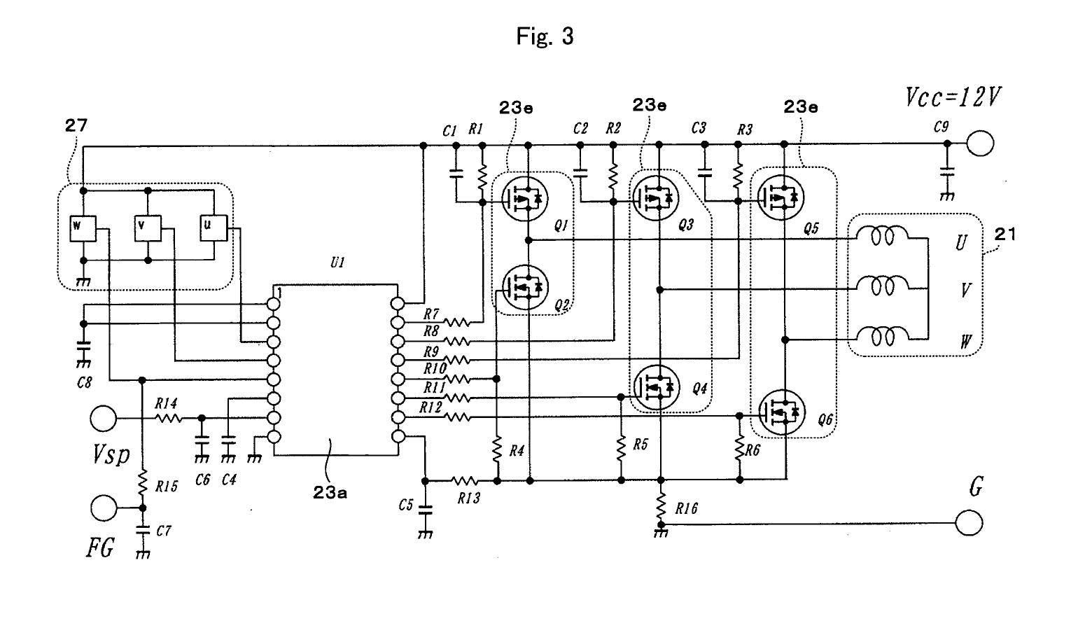

In FIGS. 2(a) and 2(b), the control circuit board 23 is disposed with the drive control IC 23a as described above and is provided with the extending parts 23b which are formed so as to extend toward the inner wall of the fan case 30. Specifically, the front face of the control circuit board 23 shown in FIG. 2(a) is disposed with the inserting connection part 23c, which is inserted into the connecting part 24, and the connecting part 23d for power supply or control lines. The inserting connection part 23c is, for example, in a contact structure which is formed on the control circuit board 23. The connecting part 23d is disposed on the extending part 23b at a position on an inner wall side of the fan case (frame) 30. Therefore, the connecting part 23d is structured so that an effect due to airflow from the inlet port 400 to the outlet port 500 is not largely incurred and so that connecting wires are easily drawn out from the slit 30a of the fan case (frame) 30. In addition, the rear face of the control circuit board 23 shown in FIG. 2(b) is provided with three FET units 23e (example of the electric current supply means) for switching and supplying an electric current to the drive coil 21 on the basis of a control signal from the drive control IC 23a. Each of the FET units 23e is respectively structured of two FETs (see FIG. 3 described below). Further, in FIG. 2(b), the most left side FET unit 23e is disposed on the extending part 23b of the control circuit board 23. In this embodiment, only one FET unit 23e is disposed on the extending part 23b but, for example, two or three FET units 23e may be disposed on the extending part 23b. Alternatively, all of six (two by three pairs) FETs (for example, MOSFET) which structure the individual FET unit 23e may be disposed on the extending part 23b.

In the fan motor 1 in accordance with this embodiment, as shown in FIG. 1(a), the sensor circuit board 22 is disposed within the frame in a perpendicular manner to the rotation shaft 14. Further, the control circuit board 23 is disposed within the fan case (frame) 30 in a parallel manner to the rotation shaft 14. Therefore, air which is sent from the inlet port 400 toward the inside of the fan case (frame) 30 by the blade part 11 and passed through the guide blade 19 is directly (forcibly) blown on the front-rear face of the control circuit board 23 and on the front-rear face of the extending part 23b. In this manner, the FET unit 23e which is disposed on the extending part 23b is effectively air-cooled and thus heat radiation characteristic is improved.

### [Electrical Structure]

FIG. 3 is a circuit diagram showing an electrical structure of the fan motor 1 in accordance with an embodiment of the present invention. Respective electric elements shown in FIG. 3 are disposed on the sensor circuit board 22 or the control circuit board 23.

In FIG. 3, the electrical structure of the fan motor 1 mainly includes the drive control IC 23a which controls switching of polarity of the drive coil 21, a magnetic pole detection sensor 27 for generating a magnetic pole detection signal, and three FET units 23e for supplying an electric current to the drive coil 21 (“U”-phase, “V”-phase and “W”-phase).

The magnetic pole detection sensor 27 is structured of three Hall elements (“U”-phase, “V”-phase and “W”-phase) for detecting the position of the magnet 12. The drive control IC 23a is capable of recognizing a rotational state of the blade part 11 by receiving electric signals from the Hall elements. A type using InSb or a type using GaAs may be used as the Hall element but any type may be used. Further, in this embodiment, the Hall IC is used to detect the magnetic pole.

A “Vsp” terminal is a terminal for receiving a control signal which is sent from a high-order device and an “FG” terminal is a terminal for outputting an “FG” signal which is periodically varied depending on the rotation number of the blade part 11. The control signal which is sent from the high-order device is a PWM signal in a PWM control system. The PWM control system is a system in which a width ratio (so-called duty ratio) of a voltage pulse is varied to control a power supply. On the other hand, the FG signal is generated on the basis of an electric signal which is received by the Hall IC (Hall element). In this embodiment, a “Vcc” terminal is a terminal to which a power supply of DC voltage 12V is connected and a “G” terminal is a ground terminal (GND terminal).

### [Effects of Embodiment]

According to the fan motor 1 in accordance with the embodiment described above, the FET unit 23e which is a main heat generating source is disposed on the extending part 23b of the control circuit board 23. Therefore, air which is flown from the inlet port 400 toward the outlet port 500 through the guide blade 19 is directly blown on the FET unit 23e and thus heat radiation characteristic can be improved. Especially, for example, in an IU server, the number of fans for cooling is limited (for example, one for each server). Therefore, in this case, a rotation number of one fan motor is required to increase to attain a high air-quantity. However, when a rotation number is increased, a problem of heat generation may occur. According to the fan motor 1 in accordance with the embodiment described above, since the above-mentioned countermeasure for heat radiation is adopted, the problem of heat generation can be eliminated (as a high air-quantity is required, strength of wind blowing on the control circuit board 23 is increased and, as a result, heat radiation characteristic can be improved).

Therefore, according to the fan motor 1, the number of fan motors used in one server can be reduced. Further, according to the fan motor 1 whose heat radiation characteristic is improved, another heat radiation countermeasure such as a heat sink can be omitted. Further, the control circuit board may be covered by another additional member and, in this case, an opening may be formed in the additional member.

Further, the sensor circuit board 22 is separately provided from the control circuit board 23 and is disposed to be perpendicular to the rotation shaft 14. Therefore, the circuit board (control circuit board and sensor circuit board) are accommodated within the fan case (frame) 30 having a limited space and thus the size of the fan motor can be reduced. Further, a degree of freedom of arrangement of the control circuit board having a large heat generating amount and the sensor circuit board having a relatively little heat generating amount is improved or a degree of freedom of arrangement of components having different heat generating amounts is improved.

Further, as shown in FIGS. 2(a) and 2(b), the connecting part 23d for power supply or for control lines is arranged near the inner wall side on the extending part 23b of the control circuit board 23. Therefore, the connecting wires can be easily connected.

Further, the control circuit board 23 is fixed to the slot 25a and the extending part 23b is fixed by the circuit board support part 28. Especially, the extending part 23b is inserted into the groove part 28a of the circuit board support part 28 to be fixed further securely. Therefore, wobbling of the control circuit board 23 is prevented.

Further, as shown in FIG. 1(b), the face (convex face 28b) of the circuit board support part 28 opposite to the face formed with the groove part 28a is formed in a stream-line shape. Therefore, disturbance of airflow which is blown through the guide blade 19 is restrained.

Further, as shown in FIG. 1(a), since the ball bearing 16 is used for supporting a part of the rotation shaft 14, the blade part 11 is prevented from being rotated while moving up and down and, as a result, occurrence of unusual noise due to impact and deterioration of rotation efficiency can be prevented.

### Modified Example

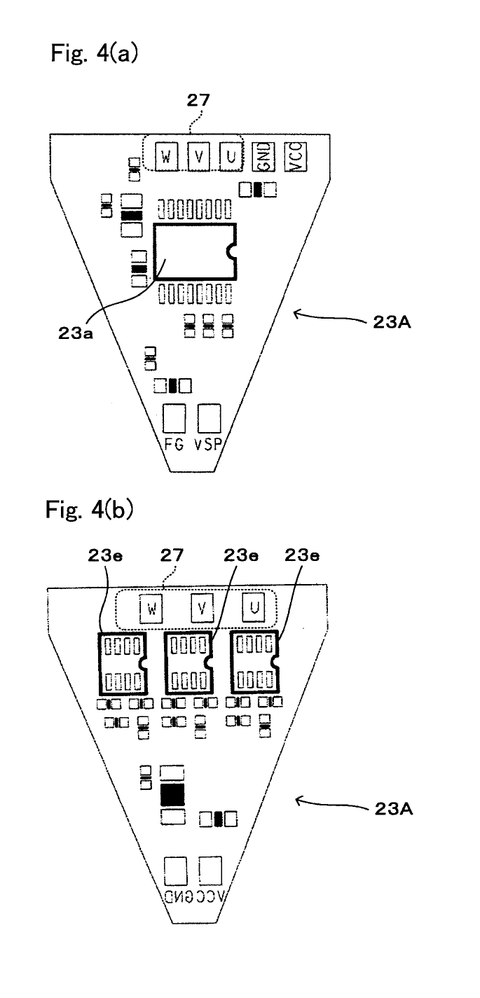

FIGS. 4(a) and 4(b) are enlarged views showing a control circuit board 23A which is mounted on a fan motor 1A in accordance with another embodiment of the present invention. Especially, as shown in FIG. 4(a), a front face of the control circuit board 23A is disposed with a drive control IC 23a and, as shown in FIG. 4(b), a rear face of the control circuit board 23A is disposed with three FET units 23e.

The control circuit board 23A shown in FIGS. 4(a) and 4(b) is not provided with the extending part 23b, which is different from the control circuit board 23 shown in FIGS. 2(a) and 2(b). However, even in this shape, when the cover member 25 is removed or when air holes are formed in a part of the cover member 25, air which is passed through the guide blade 19 from the inlet port 400 can be blown on the drive control IC 23a and the FET unit 23e and, as a result, heat radiation characteristic can be enhanced.

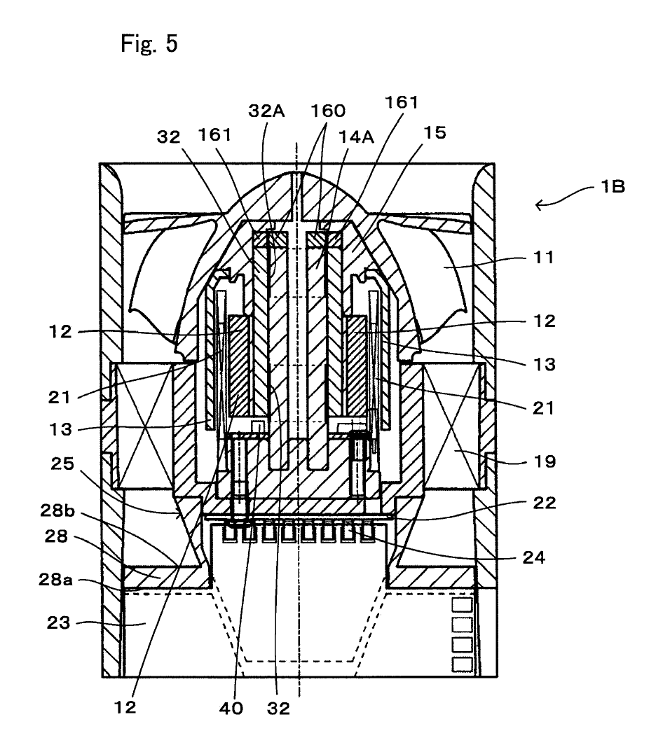

FIG. 5 is a sectional view showing a fan motor 1B in accordance with another embodiment of the present invention. A view of the fan motor 1B shown in FIG. 5 which is viewed from a lower side in the drawing is the same as that in FIG. 1(b) and thus the view is not shown.

The fan motor 1B shown in FIG. 5, which is different from the fan motor 1 shown in FIG. 1, is a shaft fixing type in which a shaft as a rotation center is not rotated. Further, a dynamic pressure bearing is adopted as a bearing instead of using the ball bearing 16. In other words, in FIG. 1, the elements structuring the rotor 100 includes the magnet 12, the yoke 13 and the hub 15, and the elements structuring the stator 200 includes the laminated core 17 and the drive coil 21, and the elements structuring the stator support member 250 includes the support member 18 and the stator support part 26. On the other hand, in FIG. 5, the elements structuring the rotor 100 includes a magnet 12, a yoke 13 and a hub 15, and the elements structuring the stator 200 includes a fixed shaft 14A and a drive coil 21. In this embodiment, the fixed shaft 14A is fixed to and stood on a bottom part of the stator support part 26 by caulking or the like. Other structure of the stator support part 26 is similar to the embodiment shown in FIG. 1(a).

Regarding a radial bearing 32, one side of the radial bearing 32 facing through a radial dynamic pressure face 32A is fixed to the hub 15 (rotation side) and the other side of the radial bearing 32 is fixed to a fixed shaft 14A side. An inner peripheral side dynamic pressure face 32A formed on a radial bearing face is circumferentially recessed with radial dynamic pressure generating grooves (not shown) having a herringbone shape so as to be divided into two blocks (within rectangular frames shown by the dotted line in FIG. 5) in an axial direction. Lubrication fluid is pressurized by pumping operations of both the radial dynamic pressure generating grooves to generate a dynamic pressure, and the radial bearing 32 is supported while being floated in a radial direction by the dynamic pressure of the lubrication fluid. Further, in this embodiment, the radial bearing 32 is mounted with magnets 160 and 161 for determining a position in an axial direction of the rotor 100 with respect to the stator 200. A position of the rotor 100 can be determined with respect to the stator 200 by means of that the magnets 160 and 161 are attracted to each other. In this manner, the present invention may be applied to the fan motor 1B in which the rotation shaft 14 is fixed.

### INDUSTRIAL APPLICABILITY

The fan motor in accordance with the present invention is effective for improving heat radiation characteristics.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A fan motor comprising:
a frame provided with an inlet port and an outlet port and formed in a hollow tubular shape;
a stator provided with a drive coil;
a stator support part which supports the stator;
a rotor which is rotatably supported by the stator support part;
a magnet which is disposed on the rotor so as to face to the drive coil;
a fan which is provided on an outer peripheral side of the rotor for generating airflow from the inlet port to the outlet port;
a control circuit board having a drive control IC for controlling switching of polarity of the drive coil; and
a mounting member which mounts the stator support part within the hollow tubular shape of the frame;
wherein the control circuit board is disposed in a substantially parallel to a rotation center axis of the rotor within the frame.

2. The fan motor according to claim 1, further comprising a sensor circuit board having a magnetic pole detection sensor for detecting a magnetic pole of the magnet to generate a magnetic pole detection signal,
wherein the sensor circuit board is disposed so that the magnetic pole detection sensor is located in a vicinity of the magnet, and the sensor circuit board is provided separately from the control circuit board.)

3. The fan motor according to claim 1, further comprising an electric current supply for supplying an electric current to the drive coil on a basis of a control signal from the drive control IC,
wherein at least a part of the electric current supply is disposed on an extending part of the control circuit board which is extended toward an inner wall of the frame.

4. The fan motor according to claim 3, further comprising a connecting part for power supply or for a control line which is provided on the extending part near the inner wall of the frame.

5. The fan motor according to claim 2, further comprising a cover member which is fixed to the stator support part for covering the sensor circuit board,
wherein the cover member is formed with a slot which is cut in a direction parallel to the control circuit board.

6. The fan motor according to claim 5, wherein the cover member is formed with a circuit board support part for supporting the control circuit board which is extended toward an inner wall of the frame from an end part of the slot in a direction perpendicular to the rotation center axis.

7. The fan motor according to claim 6, wherein the circuit board support part is formed with a groove part for supporting the extending part of the control circuit board.

8. The fan motor according to claim 6, wherein a face of the circuit board support part which is opposite to a face formed with the groove part is formed in a stream-line shape whose thickness becomes thinner toward windward of the airflow.

9. The fan motor according to claim 2, further comprising an electric current supply for supplying an electric current to the drive coil on a basis of a control signal from the drive control IC,
wherein at least a part of the electric current supply is disposed on an extending part of the control circuit board which is extended toward an inner wall of the frame.

10. The fan motor according to claim 3, further comprising a cover member which is fixed to the stator support part for covering the sensor circuit board,
wherein the cover member is formed with a slot which is cut in a direction parallel to the control circuit board.

11. The fan motor according to claim 4, further comprising a cover member which is fixed to the stator support part for covering the sensor circuit board,
wherein the cover member is formed with a slot which is cut in a direction parallel to the control circuit board.

12. The fan motor according to claim 7, wherein a face of the circuit board support part which is opposite to a face formed with the groove part is formed in a stream-line shape whose thickness becomes thinner toward windward of the airflow.

13. The fan motor according to claim 9, further comprising a connecting part for power supply or for a control line which is provided on the extending part near the inner wall of the frame.
